(19) United States
(12) Patent Application Publication
(10) Pub. No.: US 2024/0085345 A1
(43) Pub. Date: Mar. 14, 2024

(54) METHOD AND APPARATUS FOR SEPARATION OF THE SECOND HARMONIC GENERATION COMPONENTS, THROUGH VARIATION IN THE INPUT PROBING LASER POLARIZATION

(71) Applicant: FemtoMetrix, Inc., Los Angeles, CA (US)

(72) Inventor: Timothy M. Wong, Los Angeles, CA (US)

(21) Appl. No.: 18/462,208

(22) Filed: Sep. 6, 2023

Related U.S. Application Data
(60) Provisional application No. 63/425,625, filed on Nov. 15, 2022.
(60) Provisional application No. 63/404,263, filed on Sep. 7, 2022.

(51) Int. Cl. G01N 21/95; G01N 21/21; G01N 21/63; G02F 1/37

(52) U.S. Cl. CPC G01N 21/9501; G01N 21/21; G01N 21/636; G02F 1/37; G01N 2201/06113

(57) ABSTRACT

When a high intensity Second Harmonic Signal (SHG) probing laser is incident on a wafer surface under test, the SHG response is generally the combination of a few components: contributions from interfaces between material types (e.g., the semiconductor/dielectric interface), contributions from material non-centrosymmetric bulk regions, and/or contribution from the electric field near material interfaces. To separate the various components, SHG measurements can be performed as a function of the input probing laser polarization. Described herein are methods of acquiring an SHG versus polarization curve in a manner to expedite the measurement time.

### PRIORITY CLAIM

This application claims the priority benefit of U.S. Patent Prov. App. 63/404,263, entitled METHOD AND APPARATUS FOR SEPARATION OF THE SECOND HARMONIC GENERATION COMPONENTS, THROUGH VARIATION IN THE INPUT PROBING LASER POLARIZATION, filed Sep. 7, 2022; and U.S. Patent Prov. App. 63/425,625, entitled METHOD AND APPARATUS FOR SEPARATION OF THE SECOND HARMONIC GENERATION COMPONENTS, THROUGH VARIATION IN THE INPUT PROBING LASER POLARIZATION, filed Nov. 15, 2022. Each of the above-noted applications is incorporated herein by reference in its entirety.

### BACKGROUND

The present invention is in the technical field of material characterization, and more particularly, the present invention is in the technical field of a non-contact, non-invasive methods for testing such samples.

Second-Harmonic Generation (SHG) of light is a technique that has been applied to wafer inspection, for example the detection of interface traps. SHG may also be used for measuring the thickness of thin films and has been recently proposed as a method for 3D metrology.

For some of these measurements, measuring the SHG intensity as a function of the input polarization of the pump beam (fundamental), or the polarization of the SHG signal can be beneficial. Measuring the SHG signal at multiple polarizations can provide more information about the sample, such as identifying changes in the sample geometry or identifying the location of defects more precisely.

Unfortunately, SHG measurements can have high measurement overhead per measurement, for example, if a rotation stage is used to alter the polarization angle and is rotated incrementally with discrete SHG measurements performed after the completion of increment. Consequently, even if measurement time for obtaining an SHG value at a given polarization is limited to 0.2 seconds per measurement, to acquire a 180 degree rotation with 1 degree increments will take about 36 seconds. This approach might be acceptable for the laboratory setting but less so for industrial process control applications, where speed is a premium. Also, dwelling longer on a single measurement site may cause temporary changes to the sample that interfere with the desired measurement. As a result, moving to a new sample location for each polarization angle may also be involved. Accordingly, methods for increasing the speed of SHG measurements for a range of polarization angles can be beneficial.

### SUMMARY

Various methods for improving the measurement of Second Harmonic Generation (SHG) of radiation as a function of polarization angle are described herein. For example, some methods of SHG measurement described herein comprise a series of discrete measurements at pre-determined polarization angles, with a continuous rotation of the polarization of the input beam while the SHG is being measured. The rotation angle can be synchronized to the measured SHG intensity. By knowing the angle of the polarizer during the measurement, a full or substantially full polarization curve extending over a range of angles may be measured in one continuous motion. The measurement speed of a range of polarizations may thus be improved substantially.

In various implementations, for example, the input beam polarizer is rotated at a fixed rate during the SHG intensity measurement. The polarization angle can, for example, be determined from the product of time and rotation rate. In other designs, the angle of the polarizer is determined from a measurement device affixed to the polarizer, such as a rotary scale. In some designs, the polarizer angle may be determined from feedback from the motor moving the polarizer, such as by counting steps for a stepping motor. The polarizer may thus be continuously moved from one angle to another with the angle of the polarizer and the intensity of the SHG signal synchronized. The resulting SHG intensity versus polarization angle may be properly determined in these various designs.

With certain approaches, it may also be advantageous to mathematically model the measured data so as to reduce noise or fit to a pre-determined model or interpolate between acquired data points. Accordingly, in various method disclosed herein, the measurement results of SHG intensity as a function of polarization angle may be converted to mathematical representations of the results. In some methods, the measured data is fit to a mathematical expression, such as a sine wave or a combination of sin or cosine waves such as first order sin or cosine waveforms, second order sin or cosine waveforms, higher order sin or cosine waveforms or any combination of these.

Curve fitting may provide information such as one or more parameters associated with the sample. A data model and/or machine learning may alternatively or additionally be employed. Another embodiment is to use a look-up table (LUT) to fit the data to a mathematical expression or model. The models may be determined experimentally, by computer simulations or a combination of the two.

### BRIEF DESCRIPTION OF THE DRAWINGS

FIG. 1 is a schematic drawing of a system for measuring SHG light comprising a light source such as a pulsed laser producing a beam directed onto a sample and a photodetector. The system further comprises a shutter and polarization optics supported by a rotation stage that can be rotated to rotate the polarization angle of a polarized light incident on the sample. In some examples, the light source is polarized and a waveplate (e.g., a waveplate mounted on the rotation stage) shifts or rotates the polarization.

FIG. 2 is a block diagram showing various components of an example SHG measurement system. In particular, a computer is shown in electrical communication with (a) a polarization rotation stage and (b) a controller in communication with a photodetector and a shutter. After an SHG signal is acquired for a range of polarization angles, a software synchronization algorithm included on the computer is applied to determine which position of the SHG versus polarization angle curve correspond to the zero-degree polarization angle (e.g., p-polarized light) or other polarization reference angle. In some cases, the zero-degree polarization angle may correspond to p-polarization or s-polarization with respect to the top surface of the sample 14 on which the probe laser beam 12 is incident.

FIG. 3 is a block diagram showing various components of another example SHG measurement system. This example system includes a computer in electrical communication with (a) a polarization rotation stage having a rotation encoder and (b) a controller in communication with a photodetector and a shutter. The rotation stage has a high-speed encoder position readout or analog voltage representing the encoder position, eliminating the need to use a software synchronization algorithm.

FIG. 4 is a block diagram showing various components of another example SHG measurement system. This example system includes a computer in electrical communication with (a) a polarization rotation stage and (b) a controller in communication with a photodetector and a shutter. The polarization rotation stage is also in electrical communication with the controller. The rotation stage sends a synchronization-based signal once a reference position (e.g., the home position) of the rotation stage is reached, and the signal can be used to trigger the SHG acquisition.

### DETAILED DESCRIPTION

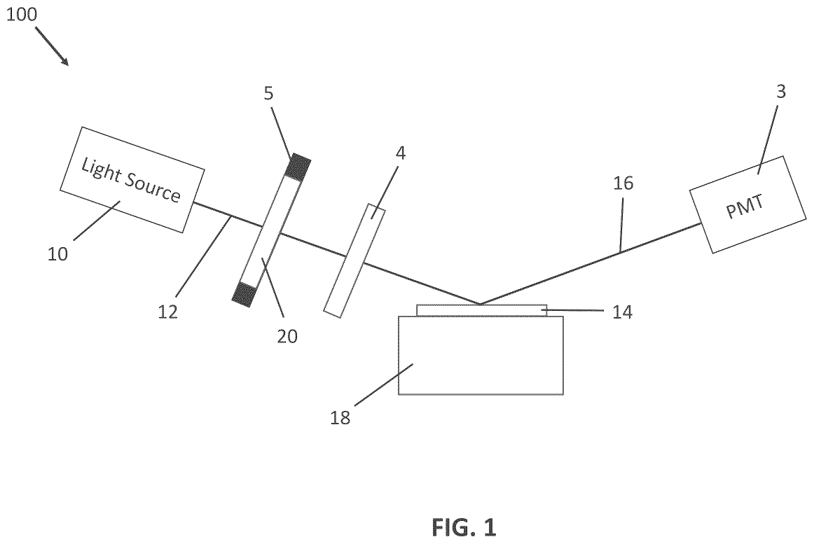

Second Harmonic Generation (SHG) can be produced by illuminating a sample such as a semiconductor wafer having device layers thereon with high intensity laser light. Accordingly, as illustrated in FIG. 1, a system 100 for measuring SHG may comprise a light source 10 such as a laser or more particularly a pulsed laser (e.g., a femtosecond pulsed laser) configured to direct light 12 such as a beam of laser pulses onto a sample 14. The system 100 also includes an optical detection system comprising a photodetector 3 positioned to detect SHG light 16 emanating from the sample 14 upon illumination with the light 12 from the light source 10. In various implementations, this photodetector 3 comprises a photomultiplier tube (PMT).

The system 100 may further comprise an optical shutter system comprising a shutter 4 (or optical switch) to control the incidence of the laser light 12 on the sample 14. This shutter or optical switch 4 may be opened to allow the laser beam 12 to be incident on the sample 14 while the photodetector 3 receives the SHG light 16 and outputs an electrical signal with incidence of light thereon. The shutter or optical switch 4 may be closed to block the light beam incident on the sample 14 when measurements, e.g., quantification, of the SHG light 16 are not being obtained.

The sample 14, which may comprise a semiconductor wafer in some cases, may be supported by a sample stage 18. In some implementations, for example, the system 100 comprises an inline system that is included inline of a semiconductor processing fab line such that SHG measurements may be obtained on a semiconductor wafer being processed. Such a semiconductor wafer may, in some cases, have devices or layers that can be used to form devices thereon. Such layers and/or devices may be formed in the semiconductor processing fab line in which this system 100 is included.

As described above, for some applications the polarization, e.g., polarization angle, of the light incident on the sample 14 is varied and the variation of resultant SHG light 16 with change in polarization can be measured. In some configurations, to vary the polarization of the light 12 incident on the sample 14, a rotatable polarizer 20 can be disposed in the optical path between the light source 10 and the sample 14 to alter the polarization of the light from the light source that is incident on the sample. The polarizer 20 may be mounted on a rotating stage 5. In various implementations, therefore, rotation of the stage 5 holding the polarizer 20 causes rotation of the polarizer and rotation of polarization angle of the light 12 incident on the sample 14. In some designs, a waveplate may be rotated (e.g., by the rotation stage) to alter, e.g., rotate the polarization angle of light (e.g., the probe laser beam 12). For example, the light source 10 may output polarized light (e.g., linearly polarized light) and the waveplate 20 may be rotated to rotate the polarization (e.g., the angle of polarization).

Various implementations described herein are configured so as to enable the polarization to vary, e.g., rotate, continuously over a range of angles. Such an approach may be faster than stepping through a number of discrete angles and stopping to measure the SHG signal at each of those separate angles. For example, in some implementations, the rotation is not stopped repeatedly to obtain SHG measurements. In some cases, the rotation may not even be slowed down repeatedly to obtain SHG measurements. Accordingly, various designs are described herein to facilitate the continuous rotation of the polarization of light incident on the sample 14 and simultaneous collection of resultant SHG light 16.

In various implementations of SHG measurement systems 100 such as shown in FIG. 1, the rotational stage 5 for the input polarization waveplate or polarizer 20 can move at a constant angular velocity while the photodetector 3 measures the varying amount or intensity of the SHG light 16 from the sample 14. In some cases, the stage 5 rotation and the SHG acquisition can be started simultaneously, with no intentional synchronization between the two respective components/sub-systems. After the SHG dependency on variation of polarization angle is acquired, a software synchronization algorithm can be applied to determine which values of SHG, analogous to position of the SHG curve, correspond to the zero-degree polarization angle, which may correspond to p-polarized light, or to another reference angle. Zero degree polarization will not always correspond to the max signal. In some case, it corresponds to min signal. In some cases, the maximum will be at 0 degrees, 45 degrees, or 90 degrees. The software may comprise data fitting algorithm. In some implementations, a formula and one or more possibly a plurality of variables are employed to perform the fitting. In some implementations, the zero degree phase angle is one of the variables. In some implementations, another reference angle is used. The SHG strength for other polarizations angles can be determined when the zero-degree polarization location or other reference angle is known. The rate of rotation of the rotation stage may also be known. This can be achieved, for example, if the software is employed to perform the fitting. In some cases, the curve fitting can also be used to assess or determine the uncertainty of the polarization. In some implementations, the zero degree position may not be critical. In some cases the maximum value is desired and in some cases, different peaks are at different polarization angles, and the relative strength of the peaks is obtained and employed. In some implementations, the relative intensity of the peaks, or the symmetry of the curve provide information regarding the property of the thin film. In some cases, information is obtain and/or one or more parameters associated with the sample are obtained, by curve fitting the SHG signal versus polarization angle distribution without needing to obtain and/or obtaining the zero reference angle or a non-zero reference angle.

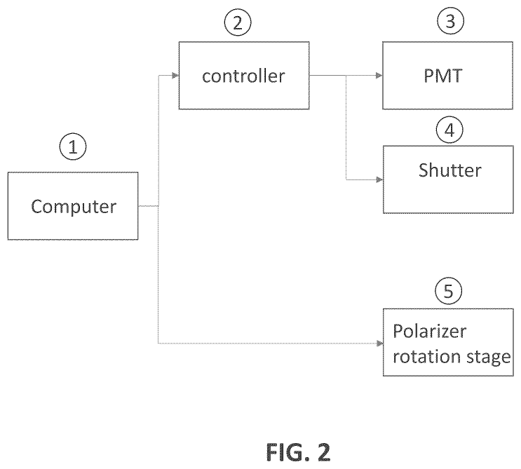

FIG. 2 is a block diagram schematically showing the interconnection of various components that may be included in a system 100 for measuring SHG. FIG. 2, for example, shows various components within electronics used in the system 100 for measuring SHG and how the components may be interconnected. The system 100, for example, includes a computer 1 electrically connected in parallel with a controller 2 and the polarizer rotation stage 5. The controller 2 is electrically connected to and communicates with both the photodetector, e.g., the photomultiplier tube (PMT) 3 and the optical shutter 4. In various implementation, the controller provides timing between components (e.g., detector/detector electronics, shutter/optical switch, rotation stage, or any combination of these) and/or synchronizes various components (e.g., detector/detector electronics, shutter/optical switch, rotation stage, or any combination of these) together. The PMT 3 is used to capture the SHG response while the shutter 4 is used to enable and abruptly disable the SHG probing laser 10 by alternately transmitting and blocking the probe laser beam 12. Not all the component of the system 100, such as the light source 10, sample 14, and sample stage 18 are shown in the block diagram of FIG. 2.

In various implementations, the polarizer rotation stage 5 may rotate at a constant angular velocity of, for example, 16 degrees per second. In some implementations, the polarizer rotation stage 5 begins movement prior to the shutter 4 opening and/or signal collected from the photodetector or data collected regarding the strength of the SHG light 16. The rotation stage 5, for example, can be caused to rotate at least until a constant velocity of rotation is achieved. For example, the polarizer rotation stage 5 can be initialized to the polar angle of −5 degrees so that by the time the rotation stage reaches 0 degrees, the rotation stage is rotating at a constant angular velocity. Additionally, in some implementations, the polarizer rotation stage 5 ends movement after to the shutter 4 is closed and/or signal collected from the photodetector 3 or data collected regarding the strength of the SHG light 16 is ceased. The rotation stage 5, for example, can be caused to rotate even after the shutter 4 is closed and/or signal collected from the photodetector 3 or data collected regarding the strength of the SHG light 16 is terminated such that a constant velocity of rotation is maintained through the end of the measurements. For example, in cases where measurements are to be obtained over a range of measurement angles of 180 degrees, the rotation stage 5 may be rotated to 185 degrees before stopping such that the rotation stage 5 remains at a constant velocity when its angle passes through 180 degrees. Of course, the range of angles over which measurements are perform and/or data is collected may be larger or smaller and/or can be shifted and/or the reference angle may or may not be zero.

A software-based synchronization between the SHG measurement (e.g., measurement of SHG light intensity) obtained and polarizer movement (e.g., angle of rotation) can then be performed as described above. After the SHG dependency on variation of polarization angle is acquired, for example, a software synchronization algorithm can be applied to determine which values, analogous to the position on the SHG vs. polarization angle curve, correspond to a zero-degree polarization angle reference. The zero-degree polarization reference may comprise, for example, the zero-degree polarization angle. The zero-degree polarization reference may also comprise, for example, a rotation position of the rotation stage corresponding to the zero-degree polarization angle, an index for identifying the zero-degree angles of polarization, or an index for identifying data associated with the zero-degree angles of polarization. The SHG strength of other polarizations angles can be determined when the zero-degree polarization location is known. The rate of rotation of the rotation stage 5 may also be used in the calculations in various implementations. In various implementations, the computer 1 electrically connected and in communication with the controller 2 and the polarization rotation stage 5 determine the zero-degree polarization location and/or the SHG strength for other polarization angles. For example, the computer can determine other SHG based values for other polarizations angles when the zero-degree polarization reference is known. The computer can use the constant rate of rotation to determine, for example, a non-zero polarization angle, an SHG measurement associated with a non-zero polarization angle, a value calculated from a non-zero polarization angle, or a value calculated from an SHG measurement associated with a non-zero polarization angle. In other implementation, the zero-degree polarization reference need not be determine but instead a non-zero polarization reference may be determined. The non-zero polarization reference may comprise, for example, a rotation position of the rotation stage corresponding to the non-zero polarization angle or reference polarization angle, an index for identifying the non-zero angle of polarization or reference polarization angle, or an index for identifying data associated with the non-zero angle of polarization or reference polarization angle. The SHG strength of other polarizations angles can be determined when the non-zero polarization or reference polarization location is known. The rate of rotation of the rotation stage 5 may also be used in the calculations in various implementations.

To determine the zero-polarization angle reference, other reference angle, or other information, the SHG measurements can be fit to a model such as a portion of a sinusoid or combination of sinusoids. The equation may comprise, for example, some combination of second and first order sine and/or cosine functions and/or higher order sine and/or cosine functions or any combination thereof. The zero-polarization angle or other reference angle may, for example, correspond to a peak of the sinusoid or combination of sinusoids such as first and/or second and/or higher order sine and/or cosine functions. Once the zero-polarization angle reference or other reference angle is determined, the different angles for which SHG measurements were obtained can also be identified. Accordingly, in various implementations, the polarization angle can be rotated continuously through a range of angles to obtain SHG measurements for a significant number of angles without stopping for a while at each angle and introducing significant delay. However, a fitting algorithm may be employed to obtain one or more the parameters of interest possibly several parameters at the same time possibly without determining the zero-polarization angle or other reference angle.

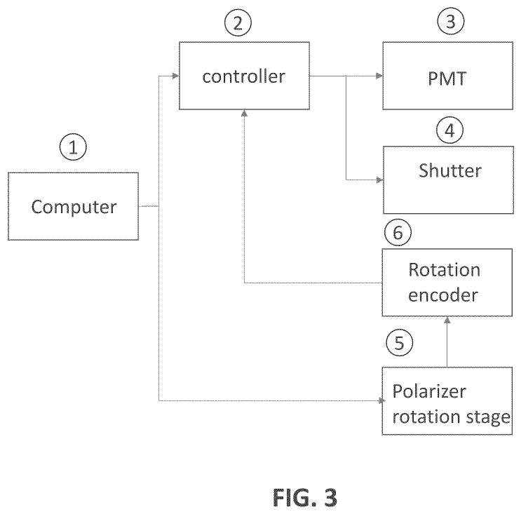

Other methods and system configurations can be used. For example, as illustrated in FIG. 3, in some designs, the rotation stage 5 has an encoder 6 such as a high-speed encoder. The encoder 6 may have a position readout or analog voltage that represent the encoder or rotation stage position. In some implementations, the position readout can be a counter that counts the number of sends to the motor of the polarization rotation stage 5. In various implementations, the SHG acquisition system or optical detection system will read the SHG signal, and the encoder 6 will read the stage position simultaneously as a function of time. Therefore, a software synchronization algorithm need not be used to locate the zero position or other reference angle or position. Additionally, the angular velocity does not need to be constant.

FIG. 3 shows various components within electronics used in the system 100 for measuring SHG and how the components may be interconnected. FIG. 3, for example, shows the computer 1 electrically connected in parallel with a controller 2 and the polarizer rotation stage 5 as also shown in FIG. 2. The controller 2 is electrically connected and communicates with both the photomultiplier tube (PMT) 3 and the optical shutter 4. The PMT 3 is used to capture the SHG response while the shutter or optical switch 4 is used to enable the SHG probing laser 10 and abruptly disable the SHG probing laser. FIG. 3 also shows the encoder 6 electrically connected and in communication with the rotation stage 5. The encoder 6 has an output that outputs information relating to the rotational position of said rotation stage 5. The electronics are configured to use the information from the output of the encoder 6 to determine a non-zero polarization angle, an SHG measurement associated with a non-zero polarization angle, a value calculated from a non-zero polarization angle, or a value calculated from an SHG measurement associated with a non-zero polarization angle, for example. FIG. 3 shows the encoder 6 and this output electrically connected and in communication with the controller 2. In various implementations, for example, the controller comprises electronics that can read the input data and respond in “real time” or at least faster than, for example, a computer operating such as a computer using Window OS.

In some implementations, the polarizer rotation stage 5 rotates at a constant angular velocity of, for example, 16 degrees per second and its position is determined by a rotation encoder 6 although the polarization rotation stage need not rotate at a constant velocity nor is the velocity limited to 16 degrees per second. The controller 2 can synchronize the polarizer stage 5 position through communication with the rotation encoder 6, while simultaneously monitoring the SHG signal by communicating with the PMT 3 and shutter 4.

In some implementations, the polarizer rotation stage 5 begins movement prior to the shutter or optical switch 4 opening and/or signal being collected from the photodetector 3 or data collected regarding the strength of the SHG light 16. The rotation stage 5, for example, can be caused to rotate at least until a constant velocity of rotation is achieved. For example, the polarizer rotation stage 5 can be initialized to the polar angle of −5 degrees so that by the time the rotation stage reaches 0 degrees, the rotation stage is rotating at a constant angular velocity. Additionally, in some implementations, the polarizer rotation stage 5 ends movement after to the shutter or optical switch 4 is closed and/or signal collected from the photodetector or data collected regarding the strength of the SHG light 16 is ceased. The rotation stage 5, for example, can be caused to rotate even after the shutter or optical switch 4 is closed and/or signal collected from the photodetector or data collected regarding the strength of the SHG light 16 is terminated such that a constant velocity of rotation is maintained through the end of the measurements. For example, in cases where measurements are to be obtained over a range of measurement angles of 180 degrees, the rotation stage 5 may be rotated to 185 degrees before stopping such that the rotation stage 5 remains at a constant velocity when its angle passes through 180 degrees. Of course, the range of angles over which measurements are performed and/or data is collected may be larger or smaller and/or the angles and/or range of angles can be shifted and thus be different.

Other implementations for monitoring the movement of the rotation stage are possible. For example, in some designs, a rotary scale may be used. The rotary scale may be used to provide information to track the rotation of the rotation stage, polarization optics, (e.g., polarizer and/or waveplate), the polarization (e.g., polarization angle) of the light or any combination of these.

Additionally or alternatively, in some designs, the rotation stage is rotated using a stepper motor. The steps of the rotation stage may be counted or monitored to track the rotation of the rotation stage, polarization optics, (e.g., polarizer and/or waveplate), the polarization (e.g., polarization angle) of the light or any combination of these.

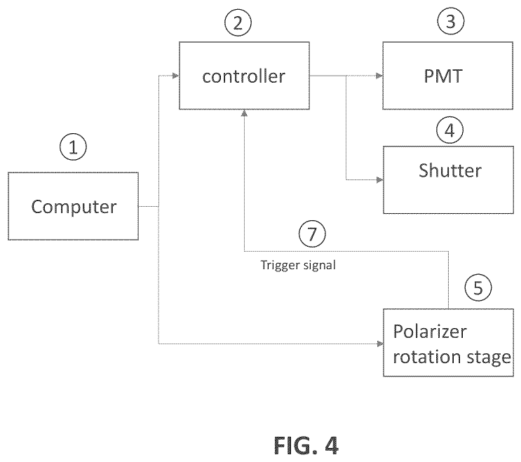

Other methods and system configurations are also possible. For example, as illustrated in FIG. 4, in some designs configured to simultaneously alter the polarization, e.g. polarization angle, of incident laser light and obtain SHG measurements, the rotation stage 5 sends a synchronization signal 7 once a particular position, e.g., the home position, of the rotation stage is reached. This synchronization signal 7 can be used to trigger the SHG acquisition. In some implementations, however, due to synchronization signal delay time, the SHG measurement is not triggered at the 0 degree position. Instead, the sync signal 7 can be passed through a digital delay line—to trigger the SHG acquisition at the desired position. A delay line can be, for example, a digital circuit or software delay so the controller fire a signal after certain delay. Accordingly, the SHG measurement can be commenced at any angle. However, such a design may provide for the SHG measurement to be synchronized with the rotation of the rotation stage and thus the rotation of the polarization of light 12 incident on the sample 14. Accordingly, in various implementations, the SHG measurement values may be associated with known angles of the polarization. Additionally, in some implementations, such SHG measurements may be consistently and accurately repeated through the same range of angles or alternatively through different ranges of angles.

FIG. 4 shows various components within electronics used in the system 100 for measuring SHG and how the components may be interconnected. FIG. 4, for example, shows the computer 1 electrically connected in parallel to the controller 2 and the polarizer rotation stage 5. The controller 2 is electrically connected to and communicates with both a photomultiplier tube (PMT) 3, and the optical shutter or switch 4. The PMT 3 is used to capture the SHG response while the shutter or optical switch 4 is used to enable the SHG probing laser 10 and abruptly disable the SHG probing laser. In some implementations, the polarizer rotation stage 5 rotates at a constant angular velocity of, for example, 16 degrees per second, and its position is determined by sending a synchronization-based trigger signal 7 from the rotation stage 5, to the controller 2, for example, when the home or designated position of the rotation stage, which may be at an arbitrary angle, is reached. The controller 2 is able to be alerted to when the polarizer stage 5 has a position corresponding to the home or designated position by receiving the trigger signal communication 7. The controller 2 can also simultaneously monitor the SHG signal by communicating with the PMT 3 and shutter or optical switch 4. In the design shown in FIG. 4, the electronics are configured to receive a trigger signal indicative that the rotation stage 5 is at a particular angle of rotation. The electronics are further in electrical communication with the optical detection system and configured to obtain a sequence of measurements of the SHG light for a range of polarization angles using the trigger signal to synchronize the polarization angles with measurements of said SHG light. The trigger signal may be carried to the electronics via an electrical line. As discussed above, the electrical line may comprise a delay line, which may comprises a digital circuit and/or software, in some implementations.

In some cases, the trigger signal can be used to trigger the SHG acquisition. The electronics may be configured to initiate collection of data for a sequence of SHG measurements after, for example, upon receiving said trigger signal or shortly thereafter. The electronics may be configured to use the rate of rotation of the rotation stage to determine polarization angles. For example, the electronics may use the rate of rotation to determine a polarization angle based on a difference between rotational positions of the rotation stage corresponding to SHG measurement and reception of the trigger signal. In some implementations, the electronics may be configured to drive the rotation stage to rotate at a constant rate of rotation. The electronics may be configured to use the constant rate of rotation to determine a polarization angle, a value calculated from a polarization angle, an SHG measurement associated with a polarization angle, or a value calculated from an SHG measurement associated with a polarization angle.

In some implementations, the polarizer rotation stage 5 begins movement prior to the shutter or optical switch 4 opening and/or signal being collected from the photodetector 3 or data collected regarding the strength of the SHG light 16. The rotation stage 5, for example, can be caused to rotate at least until a constant velocity of rotation is achieved. For example, the polarizer rotation stage 5 can be initialized to the polar angle of −5 degrees so that by the time the rotation stage reaches 0 degrees, the rotation stage is rotating at a constant angular velocity. Additionally, in some implementations, the polarizer rotation stage 5 ends movement after to the shutter or optical switch 4 is closed and/or signal collected from the photodetector or data collected regarding the strength of the SHG light 16 is ceased. The rotation stage 5, for example, can be caused to rotate even after the shutter or optical 4 is closed and/or signal collected from the photodetector or data collected regarding the strength of the SHG light 16 is terminated such that a constant velocity of rotation is maintained through the end of the measurements. For example, in cases where measurements are to be obtained over a range of measurement angles of 180 degrees, the rotation stage 5 may be rotated to 185 degrees before stopping such that the rotation stage 5 remains at a constant velocity when its angle passes through 180 degrees. Of course, the range of angles over which measurements are performed and/or data is collected may be larger or smaller and/or the angles and/or range of angles can be shifted and thus be different.

Various systems 10 disclosed herein are thus able to obtain SHG light measurements such as the intensity of the SHG light over a range different polarization angles of the incident probe light 12. Moreover, the polarization angles can be altered over a range without stopping or possibly even slowing down at different points (e.g., each point) to obtain the SHG measurements. SHG intensity measurements over a range of polarization angles can thus be obtain expeditiously, which may be beneficial for applications such as wafer metrology inline in a semiconductor fabrication process.

In various implementations, the polarization rotation element mounted on the rotation stage can be configured to rotate the polarization of the light beam incident on the sample while maintaining the optical power of the light beam substantially constant. For example, the polarization rotation element 20 may comprise a polarizer or a waveplate, or another polarization rotation element that receives the laser probe beam 12 and generates a transmitted light beam incident on the sample 14. In some such examples, upon being rotated by the rotation stage 5, the polarization rotation element (e.g., waveplate) 20 rotates the polarization of the transmitted light beam with respect to the polarization of laser probe beam 12 and maintains the optical power of the transmitted light beam substantially constant. In some cases, a change of the optical power (or intensity) of the transmitted light beam at different polarization angles may be significantly smaller than a change of the optical power (or intensity) of the SHG light generated via interaction of the transmitted light beam and the sample. In some cases, the optical power (or intensity) of the transmitted light beam or probe beam at different polarization angles and/or a change of the optical power (or intensity) of the transmitted light beam or probe beam at different polarization angles may be measured and/or monitored and potentially be accounted for in the resultant SHG signal. For example, in various implementations, the SHG signal is normalized based on the variation in intensity of the polarized probe beam as the probe beam polarization rotates. Increases and/or decreases in the SHG signal may, for example, be determined to be attributed to the increase and/or decreases, respectively, in probe beam.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

### Examples

### Group1

Example 1. An apparatus for performing simultaneous polarization and Second Harmonic Generation (SHG) measurements, changing the input/output polarization in small increments while acquiring the SHG signal comprising: a software synchronization algorithm applied to determine which position of the SHG curve corresponds to the zero-degree polarization angle.

Example 2. The apparatus of Example 1, further comprising a mathematical fitting model used to allow for interpolation between acquired data points and smoothing over the range of acquired measurements.

Example 3. The apparatus of Example 1, further comprising the separation of the SHG signal components, attributed to at least interfaces between material types (e.g., the semiconductor/dielectric interface), material non-centrosymmetric bulk regions, and/or the electric field near material interfaces.

Example 4. An apparatus for performing simultaneous polarization and Second Harmonic Generation (SHG) measurements, changing the input/output polarization in small increments while acquiring the SHG signal comprising: the rotation stage has a high-speed encoder position readout or analog voltage representing the encoder position. Therefore, there is no need to use software synchronization algorithm to locate the zero position.

Example 5. The apparatus of Example 4, further comprising a mathematical fitting model used to allow for interpolation between acquired data points and smoothing over the range of acquired measurements.

Example 6. The apparatus of Example 4, further comprising the case where the angular velocity does not need to be constant.

Example 7. The apparatus of Example 4, further comprising the separation of the SHG signal components, attributed to at least interfaces between material types (e.g., the semiconductor/dielectric interface), material non-centrosymmetric bulk regions, and/or the electric field near material interfaces.

Example 8. An apparatus for performing simultaneous polarization and Second Harmonic Generation (SHG) measurements, changing the input/output polarization in small increments while acquiring the SHG signal comprising: the rotation stage sends a synchronization-based signal once the home position of the rotation stage is reached, and the signal can be used to trigger the SHG acquisition.

Example 9. The apparatus of Example 8, further comprising a mathematical fitting model used to allow for interpolation between acquired data points and smoothing over the range of acquired measurements.

Example 10. The apparatus of Example 8, further comprising the separation of the SHG signal components, attributed to at least interfaces between material types (e.g., the semiconductor/dielectric interface), material non-centrosymmetric bulk regions, and/or the electric field near material interfaces.

### Group 2

Example 1. A system for measuring second harmonic generation (SHG) light produced by a sample, the system comprising:
a light source configured to direct light onto the sample to produce SHG light therefrom;
polarization optics disposed in a path of said light directed onto the sample, said polarization optics supported on a rotation stage configured to rotate so as to rotate the polarization of light directed onto said sample;
an optical detection system comprising a photodetector disposed to receive SHG light from the sample and provide an SHG signal that may vary with said rotation of said polarization angle of light from the light source incident on the sample; and
electronics configured to control the rotation of said polarization angle via rotation of said rotation stage, said electronics further in electrical communication with said optical detection system and configured to, based on the variation of the SHG light with rotation of said polarization angle, determine a zero-degree polarization angle reference.

Example 2. The system of Example 1, wherein said zero-degree polarization angle reference comprises at least one of the following: the zero-degree polarization angle, a rotation position of the rotation stage corresponding to the zero-degree polarization angle, an index associated with the zero-degree polarization angle, or an index for identifying data associated with the zero-degree polarization angle.

Example 3. The system of Example 1 or 2, wherein the electronics are configured to determine other SHG based values for other polarizations angles when the zero-degree polarization reference is known.

Example 4. The system of any of the Examples above, wherein the electronics are configured to use the rate of rotation of the rotation stage to determine polarization angle.

Example 5. The system of any of the Examples above, wherein the electronics are configured to drive the rotation stage to rotate at a constant rate of rotation.

Example 6. The system of Example 5, wherein the electronics are configured to use said constant rate of rotation to determine a non-zero polarization angle, an SHG measurement associated with a non-zero polarization angle, a value calculated from a non-zero polarization angle, or a value calculated from an SHG measurement associated with a non-zero polarization angle.

Example 7. The system of any of the Examples above, further comprising an optical shutter system comprising an optical switch or shutter configured to transmit a light beam received from said light source when in a first transmissive state, and block the transmission of the light beam when in a second blocking state such that said light beam is incident on said sample when said optical switch or shutter are in said first transmissive state and is blocked when said optical switch or shutter are in said second blocking state.

Example 8. The system of any of the Examples above, wherein the electronics comprise a computer and a controller, said computer electrically connected to said controller and said polarization rotation stage.

Example 9. The system of Example 8, wherein said controller is electrically connected to said photodetector.

Example 10. The system of Example 8 or 9, wherein said controller is electrically connected to said optical switch or shutter.

Example 11. The system of any of the Examples above, wherein said light source comprises a pulsed laser.

Example 12. The system of any of the Examples above, wherein said polarization optics comprises a polarizer.

Example 13. The system of any of the Examples above, wherein said polarization optics comprises a waveplate.

Example 14. The system of any of the Examples above, wherein said photodetector comprises a photomultiplier tube.

Example 15. The system of any of the Examples above, wherein said electronics are configured to interpolate between acquired data points that are based on SHG measurements.

Example 16. The system of Example 15, wherein said electronics are configured to use a mathematical fitting model to interpolate between said acquired data points.

Example 17. The system of any of the Examples above, wherein said electronics are configured to smooth over a range of acquired measurements.

Example 18. The system of any of the Examples above, wherein said electronics are configured to use a mathematical fitting model to smooth over a range of acquired measurements.

Example 19. The system of any of the Examples above, wherein said electronics are configured to separate out at least one contribution to the SHG signal as being from one or more of the following: interfaces between material types, material non-centrosymmetric bulk regions, or the electric field near material interfaces.

Example 20. The system of Example 19, wherein said interfaces between material types comprises a semiconductor/dielectric interface.

### Group 3

Example 1. A system for measuring second harmonic generation (SHG) light produced by a sample, the system comprising:
a light source configured to direct light onto the sample to produce SHG light therefrom;
polarization optics disposed in a path of said light directed onto the sample, said polarization optics supported on a rotation stage configured to rotate so as to rotate the polarization of light directed onto said sample;
an optical detection system comprising a photodetector disposed to receive SHG light from the sample and provide an SHG signal that may vary with said rotation of said polarization angle of light from the light source incident on the sample; and
electronics configured to control the rotation of said polarization angle via rotation of said rotation stage, said electronics further in electrical communication with said optical detection system and configured to, based on the variation of the SHG light with rotation of said polarization angle, determine a polarization angle reference.

Example 2. The system of Example 1, wherein said polarization angle reference comprises at least one of the following: a polarization reference angle, a rotation position of the rotation stage corresponding to a polarization reference angle, an index associated with a polarization reference angle, or an index for identifying data associated with a polarization reference angle.

Example 3. The system of Example 1 or 2, wherein the electronics are configured to determine other SHG based values for other polarizations angles when the polarization reference is known.

Example 4. The system of any of the Examples above, wherein the electronics are configured to use the rate of rotation of the rotation stage to determine polarization angle.

Example 5. The system of any of the Examples above, wherein the electronics are configured to drive the rotation stage to rotate at a constant rate of rotation.

Example 6. The system of Example 5, wherein the electronics are configured to use said constant rate of rotation to determine a polarization angle different from a polarization reference angle, an SHG measurement associated with a polarization angle different from a polarization reference angle, a value calculated from a polarization angle that is different from a polarization reference angle, or a value calculated from an SHG measurement associated with a polarization angle different from a polarization reference angle.

Example 7. The system of any of the Examples above, further comprising an optical shutter system comprising an optical switch or shutter configured to transmit a light beam received from said light source when in a first transmissive state, and block the transmission of the light beam when in a second blocking state such that said light beam is incident on said sample when said optical switch or shutter are in said first transmissive state and is blocked when said optical switch or shutter are in said second blocking state.

Example 8. The system of any of the Examples above, wherein the electronics comprise a computer and a controller, said computer electrically connected to said controller and said polarization rotation stage.

Example 9. The system of Example 8, wherein said controller is electrically connected to said photodetector.

Example 10. The system of Example 8 or 9, wherein said controller is electrically connected to said optical switch or shutter.

Example 11. The system of any of the Examples above, wherein said light source comprises a pulsed laser.

Example 12. The system of any of the Examples above, wherein said polarization optics comprises a polarizer.

Example 13. The system of any of the Examples above, wherein said polarization optics comprises a waveplate.

Example 14. The system of any of the Examples above, wherein said photodetector comprises a photomultiplier tube.

Example 15. The system of any of the Examples above, wherein said electronics are configured to interpolate between acquired data points that are based on SHG measurements.

Example 16. The system of Example 15, wherein said electronics are configured to use a mathematical fitting model to interpolate between said acquired data points.

Example 17. The system of any of the Examples above, wherein said electronics are configured to smooth over a range of acquired measurements.

Example 18. The system of any of the Examples above, wherein said electronics are configured to use a mathematical fitting model to smooth over a range of acquired measurements.

Example 19. The system of any of the Examples above, wherein said electronics are configured to separate out at least one contribution to the SHG signal as being from one or more of the following: interfaces between material types, material non-centrosymmetric bulk regions, or the electric field near material interfaces.

Example 20. The system of Example 19, wherein said interfaces between material types comprises a semiconductor/dielectric interface.

Example 21. The system of any of the Examples above, wherein said polarization angle reference comprises at least one of the following: the zero-degree polarization angle, a rotation position of the rotation stage corresponding to the zero-degree polarization angle, an index associated with the zero-degree polarization angle, or an index for identifying data associated with the zero-degree polarization angle.

Example 22. The system of any of the Examples above, wherein said polarization angle reference comprises the zero degree polarization angle.

Example 23. The system of any of Examples 1-21, wherein said polarization angle reference comprises at least one of the following: a non-zero polarization angle, a rotation position of the rotation stage corresponding to a non-zero polarization angle, an index associated with a non-zero polarization angle, or an index for identifying data associated with the non-zero polarization angle.

Example 24. The system of Example 23, wherein said polarization angle reference comprises a non-zero polarization angle.

### Group 4

Example 1. A system for measuring second harmonic generation (SHG) light produced by a sample, the system comprising:
a light source configured to direct light onto the sample to produce SHG light therefrom;
polarization optics disposed in a path of said light directed onto the sample, said polarization optics supported on a rotation stage configured to rotate so as to rotate the polarization of light that is directed onto said sample;
an encoder in communication with said rotation stage, said encoder having an output that outputs information relating to the rotational position of said rotation stage;
an optical detection system comprising a photodetector disposed to receive SHG light from the sample and provide an SHG signal that may vary with said rotation of said polarization angle of light from the light source incident on the sample; and
electronics configured to control the rotation of said polarization angle via rotation of said rotation stage, said encoder in electrical communications with said electronics such that said encoder outputs information relating to the rotational position of said rotation stage to said electronics such that SHG measurements at different angles can be associated with the rotation angle at which the measurement was obtained.

Example 2. The system of Example 1, wherein the electronics are configured to use the rate of rotation of the rotation stage to determine polarization angle.

Example 3. The system of Example 1 or 2, wherein the electronics are configured to drive the rotation stage to rotate at a non-constant rate of rotation.

Example 4. The system of Example 1 or 2, wherein the electronics are configured to use said information from said output of said encoder to determine a non-zero polarization angle, an SHG measurement associated with a non-zero polarization angle, a value calculated from a non-zero polarization angle, or a value calculated from an SHG measurement associated with a non-zero polarization angle.

Example 5. The system of any of the Examples above, further comprising an optical shutter system comprising an optical switch or shutter configured to transmit a light beam received from said light source when in a first transmissive state, and block the transmission of the light beam when in a second blocking state such that said light beam is incident on said sample when said optical switch or shutter are in said first transmissive state and is blocked when said optical switch or shutter are in said second blocking state.

Example 6. The system of any of the Examples above, wherein the electronics comprise a computer and a controller, said computer electrically connected to said controller and said polarization rotation stage.

Example 7. The system of Example 6, wherein said controller is electrically connected to said photodetector.

Example 8. The system of Example 6 or 7, wherein said controller is electrically connected to said optical switch or shutter.

Example 9. The system of any of Example 6-8, wherein said encoder output is electrically connected to said controller.

Example 10. The system of any of the Examples above, wherein said light source comprises a pulsed laser.

Example 11. The system of any of the Examples above, wherein said polarization optics comprises a polarizer.

Example 12. The system of any of the Examples above, wherein said polarization optics comprises a waveplate.

Example 13. The system of any of the Examples above, wherein said photodetector comprises a photomultiplier tube.

Example 14. The system of any of the Examples above, wherein said electronics are further in electrical communication with said optical detection system.

Example 15. The system of any of the Examples above, wherein said electronics are configured to interpolate between acquired data points that are based on SHG measurements.

Example 16. The system of Example 15, wherein said electronics are configured to use a mathematical fitting model to interpolate between said acquired data points.

Example 17. The system of any of the Examples above, wherein said electronics are configured to smooth over a range of acquired measurements.

Example 18. The system of any of the Examples above, wherein said electronics are configured to use a mathematical fitting model to smooth over a range of acquired measurements.

Example 19. The system of any of the Examples above, wherein said electronics are configured to separate out at least one contribution to the SHG signal as being from one or more of the following: interfaces between material types, material non-centrosymmetric bulk regions, or the electric field near material interfaces.

Example 20. The system of Example 19, wherein said interfaces between material types comprises a semiconductor/dielectric interface.

### Group 5

Example 1. A system for measuring second harmonic generation (SHG) light produced by a sample, the system comprising:
a light source configured to direct light onto the sample to produce SHG light therefrom;
polarization optics disposed in a path of said light directed onto the sample, said polarization optics supported on a rotation stage configured to rotate so as to rotate the polarization of light that is directed onto said sample;
a rotary scale configured to provide information relating to the rotational position of said rotation stage;
an optical detection system comprising a photodetector disposed to receive SHG light from the sample and provide an SHG signal that may vary with said rotation of said polarization angle of light from the light source incident on the sample; and
electronics configured to control the rotation of said polarization angle via rotation of said rotation stage, said rotary scale configure to provide information relating to the rotational movement and/or position of said rotation stage to said electronics such that SHG measurements at different angles can be associated with the rotation angle at which the measurement was obtained.

Example 2. The system of Example 1, wherein the electronics are configured to use the rate of rotation of the rotation stage to determine polarization angle.

Example 3. The system of Example 1 or 2, wherein the electronics are configured to drive the rotation stage to rotate at a non-constant rate of rotation.

Example 4. The system of Example 1 or 2, wherein the electronics are configured to use said information from said rotary scale to determine a non-zero polarization angle, an SHG measurement associated with a non-zero polarization angle, a value calculated from a non-zero polarization angle, or a value calculated from an SHG measurement associated with a non-zero polarization angle.

Example 5. The system of any of the Examples above, further comprising an optical shutter system comprising an optical switch or shutter configured to transmit a light beam received from said light source when in a first transmissive state, and block the transmission of the light beam when in a second blocking state such that said light beam is incident on said sample when said optical switch or shutter are in said first transmissive state and is blocked when said optical switch or shutter are in said second blocking state.

Example 6. The system of any of the Examples above, wherein the electronics comprise a computer and a controller, said computer electrically connected to said controller and said polarization rotation stage.

Example 7. The system of Example 6, wherein said controller is electrically connected to said photodetector.

Example 8. The system of Example 6 or 7, wherein said controller is electrically connected to said optical switch or shutter.

Example 9. The system of any of Example 6-8, wherein said rotary scale has an output that is electrically connected to said controller.

Example 10. The system of any of the Examples above, wherein said light source comprises a pulsed laser.

Example 11. The system of any of the Examples above, wherein said polarization optics comprises a polarizer.

Example 12. The system of any of the Examples above, wherein said polarization optics comprises a waveplate.

Example 13. The system of any of the Examples above, wherein said photodetector comprises a photomultiplier tube.

Example 14. The system of any of the Examples above, wherein said electronics are further in electrical communication with said optical detection system.

Example 15. The system of any of the Examples above, wherein said electronics are configured to interpolate between acquired data points that are based on SHG measurements.

Example 16. The system of Example 15, wherein said electronics are configured to use a mathematical fitting model to interpolate between said acquired data points.

Example 17. The system of any of the Examples above, wherein said electronics are configured to smooth over a range of acquired measurements.

Example 18. The system of any of the Examples above, wherein said electronics are configured to use a mathematical fitting model to smooth over a range of acquired measurements.

Example 19. The system of any of the Examples above, wherein said electronics are configured to separate out at least one contribution to the SHG signal as being from one or more of the following: interfaces between material types, material non-centrosymmetric bulk regions, or the electric field near material interfaces.

Example 20. The system of Example 19, wherein said interfaces between material types comprises a semiconductor/dielectric interface.

### Group 6

Example 1. A system for measuring second harmonic generation (SHG) light produced by a sample, the system comprising:
a light source configured to direct light onto the sample to produce SHG light therefrom;
polarization optics disposed in a path of said light directed onto the sample, said polarization optics supported on a rotation stage configured to rotate so as to rotate the polarization of light that is directed onto said sample;
a stepper motor configured to rotate said rotation stage;
an optical detection system comprising a photodetector disposed to receive SHG light from the sample and provide an SHG signal that may vary with said rotation of said polarization angle of light from the light source incident on the sample; and
electronics configured to control the stepper motor and the resultant rotation of said polarization angle via rotation of said rotation stage, said stepper motor in electrical communications with said electronics such that electronics has information relating to the rotational movement and/or position of said stepper motor and said rotation stage such that SHG measurements at different angles can be associated with the rotation angle at which the measurement was obtained.

Example 2. The system of Example 1, wherein the electronics are configured to use the rate of rotation of the rotation stage to determine polarization angle.

Example 3. The system of Example 1 or 2, wherein the electronics are configured to drive the stepper motor and the rotation stage to rotate at a non-constant rate of rotation.

Example 4. The system of Example 1 or 2, wherein the electronics are configured to use said information from regarding rotation of said stepper motor to determine a non-zero polarization angle, an SHG measurement associated with a non-zero polarization angle, a value calculated from a non-zero polarization angle, or a value calculated from an SHG measurement associated with a non-zero polarization angle.

Example 5. The system of any of the Examples above, further comprising an optical shutter system comprising an optical switch or shutter configured to transmit a light beam received from said light source when in a first transmissive state, and block the transmission of the light beam when in a second blocking state such that said light beam is incident on said sample when said optical switch or shutter are in said first transmissive state and is blocked when said optical switch or shutter are in said second blocking state.

Example 6. The system of any of the Examples above, wherein the electronics comprise a computer and a controller, said computer electrically connected to said controller and said polarization rotation stage.

Example 7. The system of Example 6, wherein said controller is electrically connected to said photodetector.

Example 8. The system of Example 6 or 7, wherein said controller is electrically connected to said optical switch or shutter.

Example 9. The system of any of Example 6-8, further comprising an encoder in communication with said rotation stage, said encoder having an output that outputs information relating to a rotational position of said rotation stage, wherein said encoder output is electrically connected to said controller.

Example 10. The system of any of the Examples above, wherein said light source comprises a pulsed laser.

Example 11. The system of any of the Examples above, wherein said polarization optics comprises a polarizer.

Example 12. The system of any of the Examples above, wherein said polarization optics comprises a waveplate.

Example 13. The system of any of the Examples above, wherein said photodetector comprises a photomultiplier tube.

Example 14. The system of any of the Examples above, wherein said electronics are further in electrical communication with said optical detection system.

Example 15. The system of any of the Examples above, wherein said electronics are configured to interpolate between acquired data points that are based on SHG measurements.

Example 16. The system of Example 15, wherein said electronics are configured to use a mathematical fitting model to interpolate between said acquired data points.

Example 17. The system of any of the Examples above, wherein said electronics are configured to smooth over a range of acquired measurements.

Example 18. The system of any of the Examples above, wherein said electronics are configured to use a mathematical fitting model to smooth over a range of acquired measurements.

Example 19. The system of any of the Examples above, wherein said electronics are configured to separate out at least one contribution to the SHG signal as being from one or more of the following: interfaces between material types, material non-centrosymmetric bulk regions, or the electric field near material interfaces.

Example 20. The system of Example 19, wherein said interfaces between material types comprises a semiconductor/dielectric interface.

### Group 7

Example 1. A system for measuring second harmonic generation (SHG) light produced by a sample, the system comprising:
a light source configured to direct light onto the sample to produce SHG light therefrom;
polarization optics disposed in a path of said light directed onto the sample, said polarization optics supported on a rotation stage configured to rotate so as to rotate the polarization of light that is directed onto said sample;
an optical detection system comprising a photodetector disposed to receive SHG light from the sample and provide an SHG signal that may vary with said rotation of said polarization angle of light from the light source incident on the sample; and
electronics configured to control the rotation of said polarization angle via rotation of said rotation stage, said electronics further in electrical communication with said optical detection system and configured to obtain a sequence of measurements of said SHG light for a range of polarization angles,
wherein said electronics is configured to receive a trigger signal indicative that said rotation stage is at a particular angle of rotation to synchronize said polarization angles with measurements of said SHG light.

Example 2. The system of Example 1, wherein the electronics are configured to receive said trigger signal from said rotation stage.

Example 3. The system of Example 1, wherein the trigger signal is carried to said electronics via an electrical line.

Example 4. The system of Example 3, wherein said electrical line comprises a delay line.

Example 5. The system of any of the Examples above, further comprising a delay line configured to introduce delay to said trigger signal.

Example 6. The system of any of the Examples above, wherein the electronics are configured to initiate collection of data for a sequence of SHG measurements after receiving said trigger signal.

Example 7. The system of any of the Examples above, wherein the electronics are configured to use the rate of rotation of the rotation stage to determine polarization angle.

Example 8. The system of any of the Examples above, wherein the electronics are configured to drive the rotation stage to rotate at a constant rate of rotation.

Example 9. The system of Example 8, wherein said electronics are configured to use said constant rate of rotation to determine a polarization angle, a value calculated from a polarization angle, an SHG measurement associated with a polarization angle, or a value calculated from an SHG measurement associated with a polarization angle.

Example 10. The system of any of the Examples above, further comprising an optical shutter system comprising an optical switch or shutter configured to transmit a light beam received from said light source when in a first transmissive state, and block the transmission of the light beam when in a second blocking state such that said light beam is incident on said sample when said optical switch or shutter are in said first transmissive state and is blocked when said optical switch or shutter are in said second blocking state.

Example 11. The system of any of the Examples above, wherein the electronics comprise a computer and a controller, said computer electrically connected to said controller and said polarization rotation stage.

Example 12. The system of Example 10, wherein said controller is electrically connected to said photodetector.

Example 13. The system of any of the Examples above, wherein the electronics comprise a computer and a controller, said computer electrically connected to said controller and said polarization rotation stage and said controller electrically connected to said optical switch or said shutter.

Example 14. The system of Example 13, wherein said controller is further electrically connected to said photodetector.

Example 15. The system of any of the Examples above, wherein said light source comprises a pulsed laser.

Example 16. The system of any of the Examples above, wherein said polarization optics comprises a polarizer.

Example 17. The system of any of the Examples above, wherein said polarization optics comprises a waveplate.

Example 18. The system of any of the Examples above, wherein said photodetector comprises a photomultiplier tube.

Example 19. The system of any of the Examples above, wherein said electronics are configured to interpolate between acquired data points that are based on SHG measurements.

Example 20. The system of Example 18, wherein said electronics are configured to use a mathematical fitting model to interpolate between said acquired data points.

Example 21. The system of any of the Examples above, wherein said electronics are configured to smooth over a range of acquired measurements.

Example 22. The system of any of the Examples above, wherein said electronics are configured to use a mathematical fitting model to smooth over a range of acquired measurements.

Example 23. The system of any of the Examples above, wherein said electronics are configured to separate out at least one contribution to the SHG signal as being from one or more of the following: interfaces between material types, material non-centrosymmetric bulk regions, or the electric field near material interfaces.

Example 24. The system of Example 23, wherein said interfaces between material types comprises a semiconductor/dielectric interface.

Example 25. The system of Example 23, wherein said delay line comprises a digital circuit.

### Group 8

Example 1. A system for measuring second harmonic generation (SHG) light produced by a sample, the system comprising:
a light source configured to direct light onto the sample to produce SHG light therefrom;
polarization optics disposed in a path of said light directed onto the sample, said polarization optics supported on a rotation stage configured to rotate so as to rotate the polarization of light directed onto said sample;
an optical detection system comprising a photodetector disposed to receive SHG light from the sample and provide an SHG signal that may vary with said rotation of said polarization angle of light from the light source incident on the sample; and
electronics configured to control the rotation of said polarization angle via rotation of said rotation stage, said electronics further in electrical communication with said optical detection system and configured to, based on the variation of the SHG light with rotation of said polarization angle, determine at least one parameter of said sample.

Example 2. The system of Example 1, wherein said electronics is configured to fit said variation of the SHG light with rotation of said polarization angle to a curve.

Example 3. The system of Example 2, wherein said curve comprises a combination of first order sin or cosine functions and second order sin or cosine functions.

Example 4. The system of Example 2, wherein said curve comprises a combination of first order sin or cosine functions or second order sin or cosine functions and higher order sin or cosine functions.

Example 5. The system of any of the Examples above, further comprising an optical shutter system comprising an optical switch or shutter configured to transmit a light beam received from said light source when in a first transmissive state, and block the transmission of the light beam when in a second blocking state such that said light beam is incident on said sample when said optical switch or shutter are in said first transmissive state and is blocked when said optical switch or shutter are in said second blocking state.

Example 6. The system of any of the Examples above, wherein the electronics comprise a computer and a controller, said computer electrically connected to said controller and said polarization rotation stage.

Example 7. The system of Example 6, wherein said controller is electrically connected to said photodetector.

Example 8. The system of Example 6 or 7, wherein said controller is electrically connected to said optical switch or shutter.

Example 9. The system of any of the Examples above, wherein said light source comprises a pulsed laser.

Example 10. The system of any of the Examples above, wherein said polarization optics comprises a polarizer.

Example 11. The system of any of the Examples above, wherein said polarization optics comprises a waveplate.

Example 12. The system of any of the Examples above, wherein said photodetector comprises a photomultiplier tube.

Example 13. The system of any of the Examples above, wherein said electronics are configured to interpolate between acquired data points that are based on SHG measurements.

Example 14. The system of Example 13, wherein said electronics are configured to use a mathematical fitting model to interpolate between said acquired data points.

Example 15. The system of any of the Examples above, wherein said electronics are configured to smooth over a range of acquired measurements.

Example 16. The system of any of the Examples above, wherein said electronics are configured to use a mathematical fitting model to smooth over a range of acquired measurements.

Example 17. The system of any of the Examples above, wherein said electronics are configured to separate out at least one contribution to the SHG signal as being from one or more of the following: interfaces between material types, material non-centrosymmetric bulk regions, or the electric field near material interfaces.

Example 18. The system of Example 17, wherein said interfaces between material types comprises a semiconductor/dielectric interface.

1. A system for measuring second harmonic generation (SHG) light produced by a sample, the system comprising:
a light source configured to direct light onto the sample to produce SHG light therefrom;
polarization optics disposed in a path of said light directed onto the sample, said polarization optics supported on a rotation stage configured to rotate so as to rotate the polarization angle of light directed onto said sample;
an optical detection system comprising a photodetector disposed to receive SHG light from the sample and provide an SHG signal that may vary with said rotation of said polarization angle of light from the light source incident on the sample; and
electronics configured to control the rotation of said polarization angle via rotation of said rotation stage, said electronics further in electrical communication with said optical detection system and configured to, based on a variation of the SHG signal with the rotation of said polarization angle of light, determine a polarization angle reference.

2. The system of claim 1, wherein said polarization angle reference comprises at least one of the following: a polarization reference angle, a rotation position of the rotation stage corresponding to a polarization reference angle, an index associated with a polarization reference angle, or an index for identifying data associated with a polarization reference angle.

3. The system of claim 1, wherein the electronics are configured to determine other SHG based values for other polarizations angles when the polarization angle reference is known.

4. The system of claim 1, wherein the electronics are configured to use the rate of rotation of the rotation stage to determine polarization angle.

5. The system of claim 1, wherein the electronics are configured to drive the rotation stage to rotate at a constant rate of rotation.

6. The system of claim 5, wherein the electronics are configured to use said constant rate of rotation to determine a polarization angle different from a polarization reference angle, an SHG measurement associated with a polarization angle different from a polarization reference angle, a value calculated from a polarization angle that is different from a polarization reference angle, or a value calculated from an SHG measurement associated with a polarization angle different from a polarization reference angle.

7. The system of claim 1, further comprising an optical shutter system comprising an optical switch or shutter configured to transmit a light beam received from said light source when in a first transmissive state, and block transmission of the light beam when in a second blocking state such that said light beam is incident on said sample when said optical switch or shutter are in said first transmissive state and is blocked when said optical switch or shutter are in said second blocking state.

8. The system of claim 7, wherein the electronics comprise a computer and a controller, said computer electrically connected to said controller and said polarization rotation stage.

9. The system of claim 8, wherein said controller is electrically connected to at least one of said photodetector, optical switch, or shutter.

10. (canceled)

11. (canceled)

12. The system of claim 1, wherein said polarization optics comprises a polarizer or a waveplate.

13. (canceled)

14. The system of claim 1, wherein said photodetector comprises a photomultiplier tube.

15. The system of claim 1, wherein said electronics are configured to interpolate between acquired data points that are based on SHG measurements.

16. The system of claim 15, wherein said electronics are configured to use a mathematical fitting model to interpolate between said acquired data points.

17. The system of claim 1, wherein said electronics are configured to smooth over a range of acquired measurements.

18. The system of claim 1, wherein said electronics are configured to use a mathematical fitting model to smooth over a range of acquired measurements.

19. The system of claim 1, wherein said electronics are configured to separate out at least one contribution to the SHG signal as being from one or more of the following: interfaces between material types, non-centrosymmetric bulk material regions, or electric field near material interfaces.

20. The system of claim 19, wherein said interfaces between material types comprises a semiconductor/dielectric interface.

21. The system of claim 1, wherein said polarization angle reference comprises at least one of the following: a zero-degree polarization angle, a rotation position of the rotation stage corresponding to a zero-degree polarization angle, an index associated with a zero-degree polarization angle, or an index for identifying data associated with a zero-degree polarization angle.

22. (canceled)

23. The system of claim 1, wherein said polarization angle reference comprises at least one of the following: a non-zero polarization angle, a rotation position of the rotation stage corresponding to a non-zero polarization angle, an index associated with a non-zero polarization angle, or an index for identifying data associated with the non-zero polarization angle.

24. The system of claim 23, wherein said polarization angle reference comprises a non-zero polarization angle.
